(19) United States
(12) Patent Application Publication
(10) Pub. No.: US 2005/0099296 A1
(43) Pub. Date: May 12, 2005

(54) Antitheft system

(76) Inventors: Shinji Matsudaira, Osaka (JP); Hiroshi Yoshida, Hyogo (JP)

Correspondence Address: Daniel N Daisak;Tyco Fire & Security Services, One Town Center Road, Boca Raton, FL, 33486, US

(21) Appl. No.: 10/475,565

(22) PCT Filed: Apr. 17, 2002
(86) PCT No.: PCT/JP02/03822

(30) Foreign Application Priority Data
Apr. 20, 2001 (JP) 123204/2001

(51) Int. Cl. G08B 13/00

(52) U.S. Cl. 340/566

(57) ABSTRACT

The present invention provides a burglar alarm system capable of accurately discriminating an alarm from a disturbance noise approximate to the alarm such as background music, ambient noises, etc. In a burglar alarm system comprising an alarm unit attached to an object to be protected from theft to emit an alarm of a particular frequency and an alarm sensor device for issuing an alarm signal upon sensing an alarm from the alarm unit, the alarm sensor device counts a predetermined number of waveform pulses of a received sound (S2, S5) more than once (S1˜S3, S4˜S6), determines, if it transpires that a differential between counted values falls within a predetermined time range, that the received sound is an alarm and issues an alarm signal (S7).

### TECHNICAL FIELD OF THE INVENTION

The present invention relates to an anti-theft system intended to protect goods for sale from theft etc., and in particular to a burglar-alarm system utilizing an alarm to be emitted by an alarm unit attached to such goods.

### BACKGROUND OF THE INVENTION

An anti-theft system such as that illustrated in FIG. 3 is commonly employed to prevent shop lifting, etc. at a retail store where compact disks, magnetic tapes, clothing garments, etc. are available to customers. The conventional anti-theft system consists of theft prevention gate 30 installed near exit 40 of the store and alarm unit 20 attached to article 50. The theft prevention gate 30 incorporates a circuit board 31 and transmitter antenna (not shown), and the circuit board 31 is provided with a transmitter circuit (not shown) which transmits an alarm activation signal to the alarm unit 20.

As shown in FIG. 4, the alarm unit 20 has a buzzer 22, a circuit board 23, a battery, etc. (not shown) each of which is housed in casing 21, and in the surface of which casing a plurality of alarm emitting holes 24 are provided and an alarm activation switch piece 25 is embedded. The buzzer 22, which is controlled by the circuit board 23, is designed to be activated when the alarm unit 20 is removed from the article 50 or passes through the theft prevention gate 30. As an alternative to providing the alarm unit 20 with the alarm activation switch piece 25, the alarm unit 20 may be attached directly to the article 50 by means of a wire, in which case when the alarm unit 20 senses that the wire has been removed or cut or passed through the theft prevention gate 30, the buzzer 22 is activated.

At a retail store, the article 50 with the alarm unit 20 affixed thereto is displayed on a rack. When a sales clerk sells the article 50 to a customer, he or she first sends a specified reset signal from an alarm deactivation device (not shown) to the circuit board 23 of the alarm unit 20 to set the alarm unit 20 such that the buzzer 22 will not be activated, then removes the alarm unit 20 from the article 50 and hands the article 50 to the customer when payment is made.

On the contrary, when the alarm unit 20 is removed from the article 50 by a customer, the alarm activation switch piece 25 becomes OFF and the buzzer 22 is activated. Further, in a case that a customer leaves a store premises taking away the article 50 with the alarm unit 20 still attached thereto, the circuit board 23 of the alarm unit 20 receives an alarm activation signal from the transmitter antenna of the theft prevention gate 30, in response to which the buzzer 22 is activated.

However, a checkout counter is usually at the back of a store, far away from the exit 40 of the store where the theft prevention gate 30 is installed and therefore, an alarm from the buzzer 22 that goes off at the exit 40 may not be readily audible from the checkout counter, especially in an environment where back ground music is present, or where many customers are present, etc.

With a view to solving the problem of the anti-theft device described above, a burglar alarm system such as illustrated in FIG. 5 is used as a supplementary device in which alarm sensor device 10 provided with microphone 11 is disposed near the theft prevention gate 30 so that the alarm sensor device 10 senses alarm 12 from the alarm unit 20 and issues alarm signal 13, which is sent through a wire or by wireless connection to a speaker 15 or lamp 16 disposed at a checkout counter 14 to alert store personnel at the checkout counter that the alarm has been activated.

Such a system as described above, however, suffers from a problem in that it may not be able to discriminate interference noise similar to that generated by an alarm, such as back ground music, ambient noise, etc. from an unrelated alarm.

Given the aforementioned problem, it is an object of the present invention to provide a burglar alarm system that can accurately sense an alarm.

It is another object of the present invention to provide a burglar alarm system provided with a function of adjusting the accuracy of determination.

### SUMMARY OF THE INVENTION

A burglar alarm system of the present invention comprises an alarm unit attached to an object to be protected from theft to emit an alarm of a particular frequency in response to wrongful conduct and an alarm sensor device for sensing an alarm from the alarm unit and generating an alarm signal, wherein said alarm sensor device counts a predetermined number of waveform pulses of received sound more than once and if it transpires that a differential between counted values falls within a predetermined time range, said received sound is regarded as an alarm and an alarm signal is issued.

Further, a burglar alarm system of the present invention comprises an alarm unit attached to an object to be protected from theft to emit an alarm of a particular frequency in response to wrongful conduct and an alarm sensor device for sensing an alarm from the alarm unit and generating an alarm signal, wherein an alarm from the alarm unit has an intermittent waveform of a constant cycle; and the alarm sensor device counts a predetermined number of waveform pulses of the alarm more than once while the alarm is continuing and if it transpires that a differential between counted values falls within a predetermined time range and that an intermittent cycle of the received sound matches an intermittent cycle of the alarm signal, it is determined that the received sound is a legitimate alarm and an alarm signal is issued.

Thus, the present invention can provide a burglar alarm system capable of accurately discriminating ambient noise approximate to an alarm such as back ground music, disturbance noises, etc. from an unrelated alarm.

In accordance with an embodiment of the present invention, a burglar alarm system has a function of adjusting a determination sensitivity level by determining more than once if a differential between counted values falls within a predetermined time range and if the aforementioned intermittent cycles match.

### BRIEF EXPLANATION OF THE DRAWINGS

FIG. 1 is a flow chart representing an operation performed by an alarm sensor device in accordance with an embodiment of a burglar alarm system of the subject invention.

FIG. 2 shows signal waveforms of the subject embodiment.

FIG. 3 is a model diagram of a burglar alarm system.

FIG. 4 is a perspective view of an alarm unit in the burglar alarm system.

FIG. 5 is a model diagram of another burglar alarm system.

### PREFERRED EMBODIMENT OF THE INVENTION

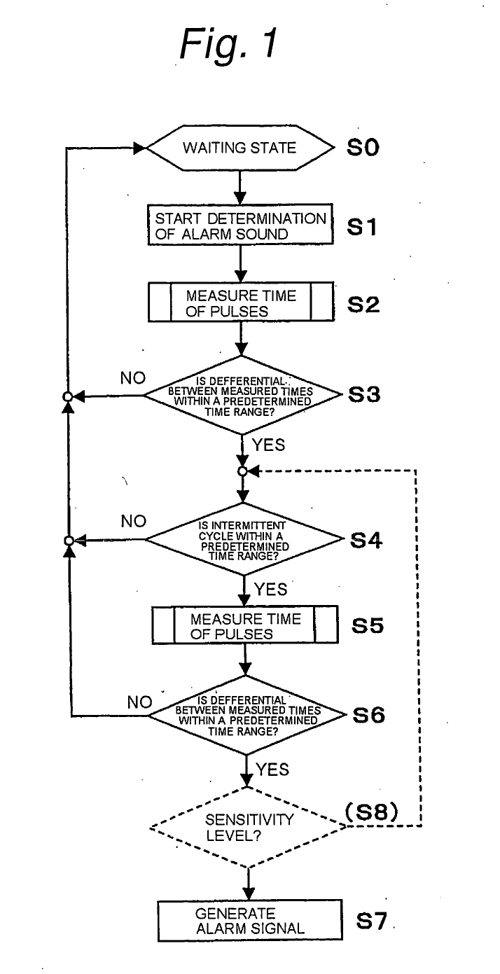

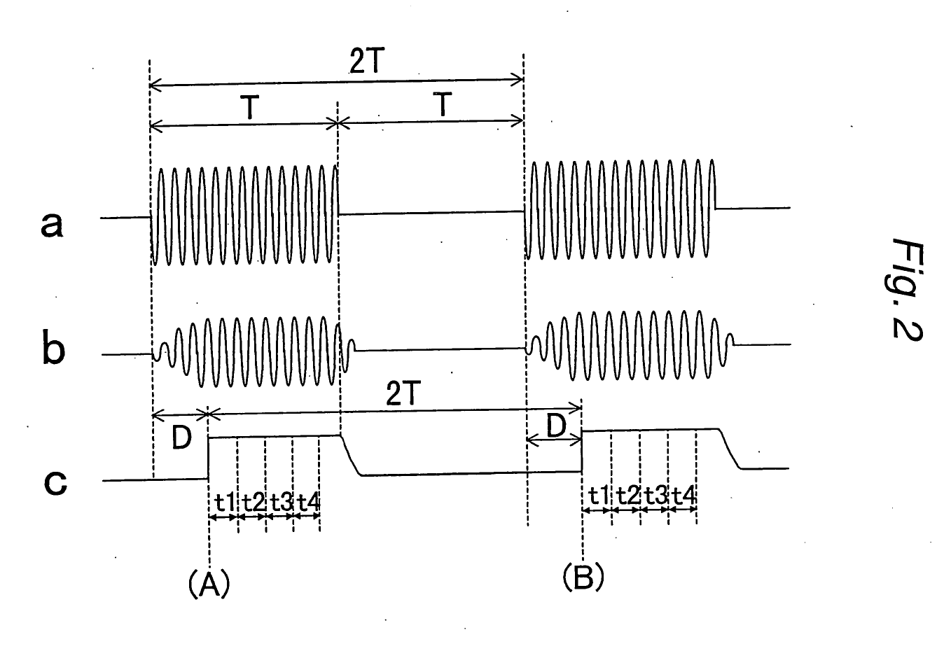

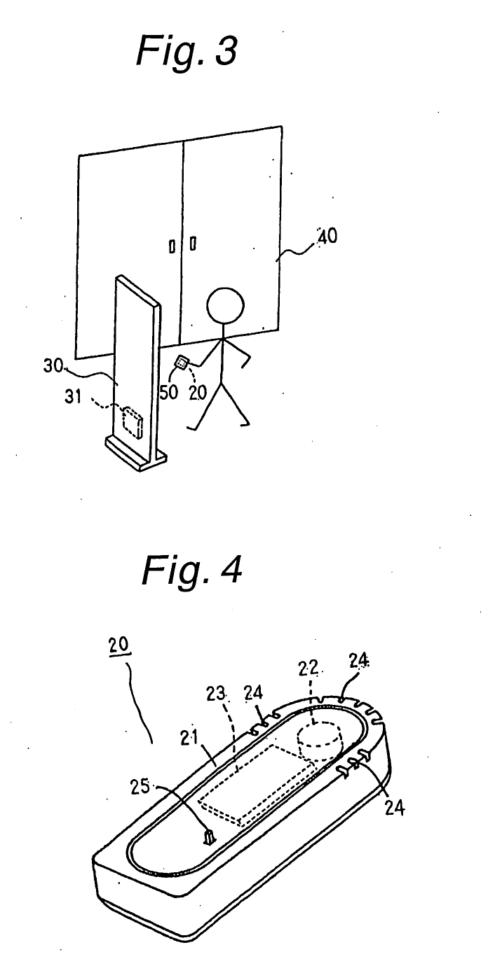

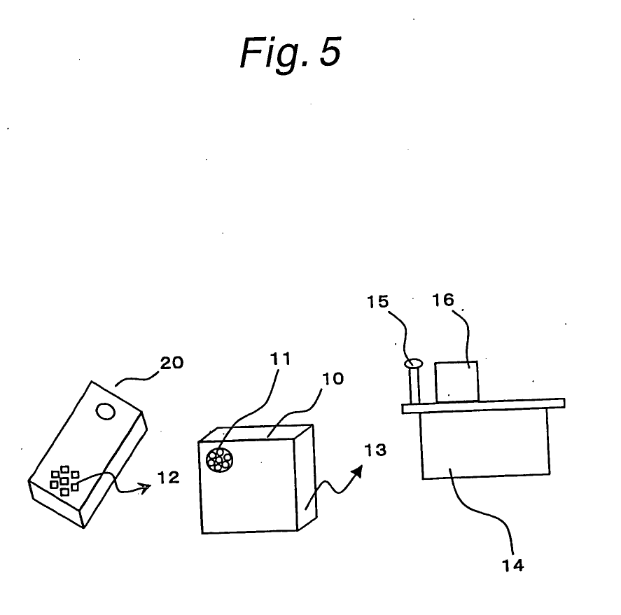

FIG. 1 is a flow chart representing an operation performed by an alarm sensor device of an embodiment of the present invention. FIG. 2 shows signal waveforms. Hereafter, the present invention will be specifically described with reference to the drawings.

As described above, in response to an unauthorized removal of an alarm unit from goods or a store, the alarm unit emits an alarm. The alarm is generated by a buzzer drive signal having an intermittent waveform of a particular frequency f (cycle: 2T, duty ratio: 50%) indicated in (a) of FIG. 2.

When a microphone of an alarm sensor device installed near a theft prevention gate or inside the premises of a store senses sound (received sound) having a frequency in the neighborhood of f, the alarm sensor device in the waiting state (S0) starts an alarm determination operation at step S1.

In such an alarm determination operation, as indicated in (b) of FIG. 2, a signal waveform of an alarm received by the alarm sensor device is unstable at a rise of a received signal because the signal has been subjected to signal processing such as amplification, transmission through a filter in the alarm sensor device, etc. Therefore, a determination operation is started at a rise (point A) of an envelope signal which rises later than the received signal by time D proportionate to filter characteristics and gradually falls at a fall of the received signal.

Once an alarm determination operation is started, the alarm unit measures a time for receiving a predetermined number of pulses (for example, 30 pulses) of the received signal more than once during the rise of the envelope signal (t1, t2, t3, t4).

At step S3, differentials between the respective measured time (t1-t2, t2-t3, t3-t4) are computed and if each differential falls within a predetermined time range (for example, ±10 μseconds), it is determined that the received signal is an alarm and the process proceeds to the next step S4. On the contrary, if any of the differentials does not fall within the predetermined time range, it is determined that the received signal is a disturbance noise or an ambient noise and the operation returns to the waiting state (S0).

At step S4, it is determined whether or not an interval between the determination operation start (point A) and the next rise (point B) of the envelope signal is not more than 2T (cycle of a buzzer drive signal)±d (for example, α=10 m seconds). If it is not more than 2T±10 μseconds), it is determined that the received signal is an alarm and the operation goes to the next step S5. On the other hand, if an interval between the rises of the envelope signal is more than 2T±10 μseconds, it is determined that the received signal is a disturbance noise and the operation returns to the waiting state (S0).

At step S5, similarly to S2, a determination operation is started at the rise (point B) of the envelope signal and time for receiving a predetermined number of pulses (for example, 30 pulses) of the received signal is measured more than once during the rise of the envelope signal (t1, t2, t3, t4).

At step S6, similarly to S3, differentials between the respective measured receiving time (t1-t2, t2-t3, t3-t4) are computed and if each differential falls within a predetermined time range (for example, ±10 μseconds), it is determined that the received signal is an alarm and the operation goes to the next step S7. On the contrary, if any of the differential does not fall within the predetermined time range, it is determined that the received signal is a disturbance noise and the operation returns to the waiting state (S0).

At step S7, the alarm sensor device emits an alarm signal to alert store personnel by means of a speaker, lamp, etc. installed at a checkout counter by an alarm, through wire, by wireless, etc. that an alarm has been issued. Since an alarm signal may be stopped by a known method, i.e. turning off a switch, transmitting a stop signal, etc., it will not be described here how to stop an alarm signal.

As described above, according to the embodiment, utilizing the fact that an alarm emitted by the alarm unit has a particular frequency f while a disturbance noise does not have such a particular frequency and its frequency change is noticeable especially during a period when the number of pulses is a few dozen, a time for receiving a predetermined number of pulses is measured more than once to determine from a differential between measured time whether a received signal is an alarm or disturbance noise.

Further, according to the embodiment, an alarm from the alarm unit of the embodiment is designed to have an intermittent waveform so as to determine whether or not an intermittent cycle of a received signal matches an intermittent cycle of the alarm, whereby it can be more accurately determined whether a received signal is an alarm or a disturbance noise.

Still further, another step S8 (indicated by dashed lines in FIG. 1) may be added between the step S6 and the step S7 in the subject embodiment to adjust a determination sensitivity level of a sensor (for example, High=0, Middle=1, Low=2), which can be optionally set, so that the operations in the steps S4˜S6 are repeated to adjust accuracy of determination. More specifically, for example, the operations in S4˜S6 are performed once at the sensitivity level Middle while the operations are repeated twice at the sensitivity level Low, thereby improving accuracy in determination.

The subject inventions are in no way restricted by the disclosed embodiment and other modifications and variations will be apparent to persons skilled in the art. The present inventions are restricted only by the scope of claims of the present inventions.

1. A burglar alarm system comprising an alarm unit attached to an object to be protected from theft to emit an alarm of a particular frequency in response to wrongful conduct and an alarm sensor device for emitting an alarm signal upon sensing an alarm from said alarm unit,
said alarm sensor device counting a predetermined number of waveform pulses of a received sound more than once, determining, if a differential between counted values falls within a specified time range, that said received sound is an alarm and issuing an alarm signal.

2. A burglar alarm system comprising an alarm unit attached to an object to be protected from theft to emit an alarm of a particular frequency in response to wrongful conduct and an alarm sensor device for emitting an alarm signal upon sensing an alarm from said alarm unit,
an alarm emitted from said alarm unit having an intermittent waveform of a constant cycle,
said alarm sensor device counting a predetermined number of waveform pulses of said alarm more than once while said alarm is continuing, determining, if a differential between counted values falls within a predetermined time range and that an intermittent cycle of said received sound matches an intermittent cycle of said alarm signal, that said received sound is an alarm and issuing an alarm signal and issuing an alarm signal.

3. The burglar alarm system as defined in claim 2, wherein determination based on a differential between said counted values and determination based on matching between said intermittent cycles are made more than once, thereby adjusting a sensitivity level.
